(19) United States
(12) Patent Application Publication
(10) Pub. No.: US 2019/0010821 A1
(43) Pub. Date: Jan. 10, 2019

(54) SYSTEMS AND METHODS FOR VIRTUAL CLEARANCE MEASUREMENT IN A GAS TURBINE

(71) Applicant: General Electric Company, Schenectady, NY (US)

(72) Inventors: Debabrata MUKHOPADHYAY, Bangalore (IN); James ADAICKALASAMY, Bangalore (IN); Muralikrishna RANGHARAJHAN, Bangalore (IN)

(21) Appl. No.: 16/001,561

(22) Filed: Jun. 6, 2018

(30) Foreign Application Priority Data
Jul. 5, 2017 (IN) 201741023637

(51) Int. Cl. F01D 11/20; F02C 9/50

(52) U.S. Cl. CPC F01D 11/20; F02C 9/50; F05D 2270/303; F05D 2270/306; F05D 2270/304; F05D 2270/20

(57) ABSTRACT

This disclosure provides systems and methods for controlling gas turbine airfoil clearance using virtual clearance measurement. The disclosure includes a gas turbine system having a stage of airfoils and a casing adjacent the stage of airfoils that define a clearance distance between them. A clearance control mechanism controllably adjusts the clearance distance based upon a clearance control signal. The clearance control signal to the clearance control mechanism is based on a virtual clearance function that generates a clearance value from at least one system measurement of the gas turbine system.

### BACKGROUND OF THE INVENTION

The disclosure relates generally to turbomachines, and more particularly, to controlling turbine clearances for operational performance and system protection in a gas turbine.

Turbomachines, such as gas turbines, include one or more rows of airfoils, including stationary airfoils referred to as stator vanes and rotating airfoils referred to as rotor blades or buckets. A gas turbine may include an axial compressor at the front, one or more combustors around the middle, and a turbine at the rear. Typically, an axial compressor has a series of stages with each stage comprising a row of rotor blades followed by a row of stationary stator vanes. Accordingly, each stage generally comprises a pair of rotor blades and stator vanes. Typically, the rotor blades increase the kinetic energy of a fluid that enters the axial compressor through an inlet and the stator vanes convert the increased kinetic energy of the fluid into static pressure through diffusion. Accordingly, both sets of airfoils play a vital role in increasing the pressure of the fluid.

Gas turbine efficiency may be closely tied to control of the fluid paths through the airfoils in the turbine section. Gaps between a stage of airfoils and the casing adjacent the airfoils may create a secondary flow path that decreases turbine efficiency. As atmospheric and/or operating temperatures increase, expansion of casings or other components may expand these gaps and lower efficiency. Gas turbines have implemented a variety of systems for actively controlling blade tip clearance between the blade tips and adjacent casing. One such system uses cooling air or another cooling system to reduce the temperature of the casing, causing it to contract and reduce the gap size. These clearance control systems may require a measurement of the gap in order to correctly control the gap width. If the gap is allowed to become too large, operating efficiency is reduced. If the gap is too small, it may cause a stall or a collision event. Various configurations of sensors for directly or indirectly measuring the gap, such as clearance probes, have been implemented. These additional sensors within the fluid path or mechanics of the gas turbine are subject to wear and failure and may not last the operational life or maintenance cycles of the gas turbine.

### BRIEF DESCRIPTION OF THE INVENTION

A first aspect of this disclosure provides a gas turbine system using a virtual clearance measurement. The gas turbine includes a stage of airfoils and a casing adjacent the stage of airfoils that define a clearance distance between the stage of airfoils and the casing. A clearance control mechanism controllably adjusts the clearance distance based upon a clearance control signal. A clearance controller provides the clearance control signal to the clearance control mechanism. The clearance controller receives a clearance value as an input to a closed loop controller that generates the clearance control signal. A virtual clearance function generates the clearance value from at least one system measurement of the gas turbine system.

A second aspect of the disclosure provides a method for controlling airfoil clearance using a virtual clearance measurement. The method comprises measuring an exhaust temperature from a gas turbine. The gas turbine includes a stage of airfoils and a casing adjacent the stage of airfoils that define a clearance distance between the stage of airfoils and the casing. A clearance value is calculated using a virtual clearance function to transform at least one combustor performance value and an exhaust temperature value into the clearance value. A clearance control signal is generated and output to a clearance control mechanism. The clearance control signal is based on a closed loop controller and the clearance value. The clearance distance between the stage of airfoils and the casing is modified in response to the clearance control value using the clearance control mechanism.

A third aspect of the disclosure a method of generating and using a virtual clearance function. A combustor performance parameter is selected for a unit design for a gas turbine. The gas turbine includes a stage of airfoils and a casing adjacent the stage of airfoils that define a clearance distance between the stage of airfoils and the casing. A performance model is selected for the unit design for the gas turbine. The performance model includes the selected combustor performance parameter, an exhaust temperature parameter, and a clearance parameter correlating to the clearance distance in a range of operating conditions. A virtual clearance function is calculated that includes a transfer function from one of the selected combustor performance parameter or the exhaust temperature parameter to the clearance parameter. The virtual clearance function is used to generate a clearance control signal to a clearance control mechanism based on measurement of the selected combustor performance parameter and the exhaust temperature parameter in the gas turbine. The clearance distance between the stage of airfoils and the casing is modified in response to the clearance control value using the clearance control mechanism.

The illustrative aspects of the present disclosure are arranged to solve the problems herein described and/or other problems not discussed.

### BRIEF DESCRIPTION OF THE DRAWINGS OF THE INVENTION

These and other features of this disclosure will be more readily understood from the following detailed description of the various aspects of the disclosure taken in conjunction with the accompanying drawings that depict various embodiments of the disclosure, in which:

FIG. 1 shows a block diagram of an example gas turbine system with shroud clearance control.

FIG. 2 shows a graph of an example virtual clearance function.

FIG. 3 shows a graph of another example virtual clearance function.

FIG. 4 shows a graph of another example virtual clearance function.

FIG. 5 shows a block diagram of an example method of implementing a virtual clearance function.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In some embodiments, aspects of the disclosure may be implemented through an existing control system for managing a gas turbine, other turbomachine, power generation facility, or portion thereof. Aspects of the disclosure may be implemented for any gas turbine that includes an existing airfoil clearance control mechanism or may be modified to include an airfoil clearance control mechanism, such as a case temperature management blower or a mechanical, hydraulic, or pneumatic actuator for adjusting the spacing between the blade tip and the adjacent casing. In some embodiments, existing clearance control mechanisms may include a feedback control loop and receive a clearance control signal to adjust shroud clearance to a desired gap clearance. Clearance distance may be measured as the distance from a distal surface of an airfoil, including any attached distal shroud, to the nearest surface of the case, representing the narrowest choke point of fluid flow through the space between the distal surface of the airfoil and the case. In some embodiments, an existing clearance controller provides closed loop control of the clearance control mechanism based on receiving a clearance measurement as an input to the controller. A gas turbine control system or integrated plant management system including gas turbine control may provide continuous, periodic, or event-based clearance measurements to the clearance controller to adjust the measured clearance distance versus the desired clearance distance. In some embodiments, the clearance controller may receive a measured clearance distance directly from a sensor system, such as a clearance probe. Whether from the control system or directly from a sensor system, the measured clearance distance is a clearance value that may be replaced by a virtual clearance measurement according to some embodiments.

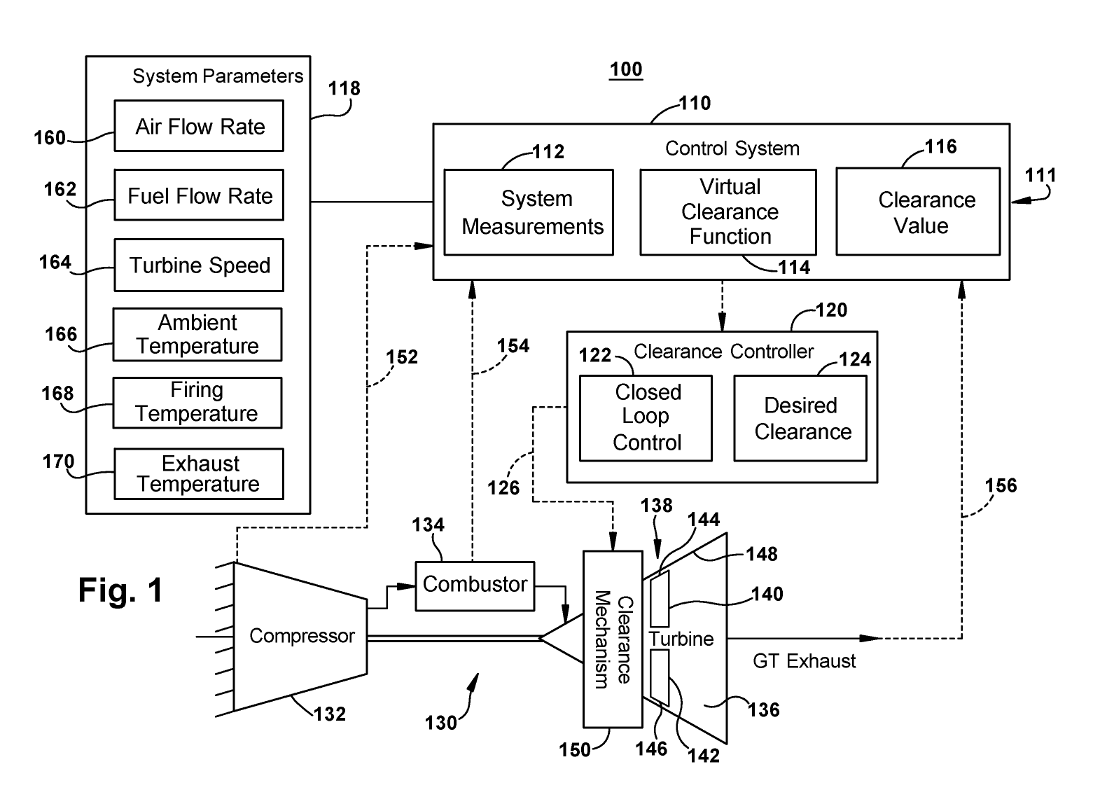

Referring to FIG. 1, an example gas turbine system 100 with virtual clearance measurement is shown. System 100 may include a control system 110 and a gas turbine 130. Control system 110 may manage operation of system 100 and may include or communicate with a variety of sensors, data channels, databases, process logic, and other control systems for tracking operations and controlling various systems, subsystems, and components of system 100. For example, control system 110 may include a power plant control system for instrumentation, visualization, automation, and parameter and/or subsystem control during operation of a power plant. Control system 110 may manage the operations of system 100, including gas turbine 130, for demand-based output, efficiency, system protection and safety, load balancing, and/or maintenance and repair. Control system 110 may include a plurality of communication channels for receiving data from sensors and/or localized control subsystems associated with each of the components of system 100, such as gas turbine 130 and sections and components thereof.

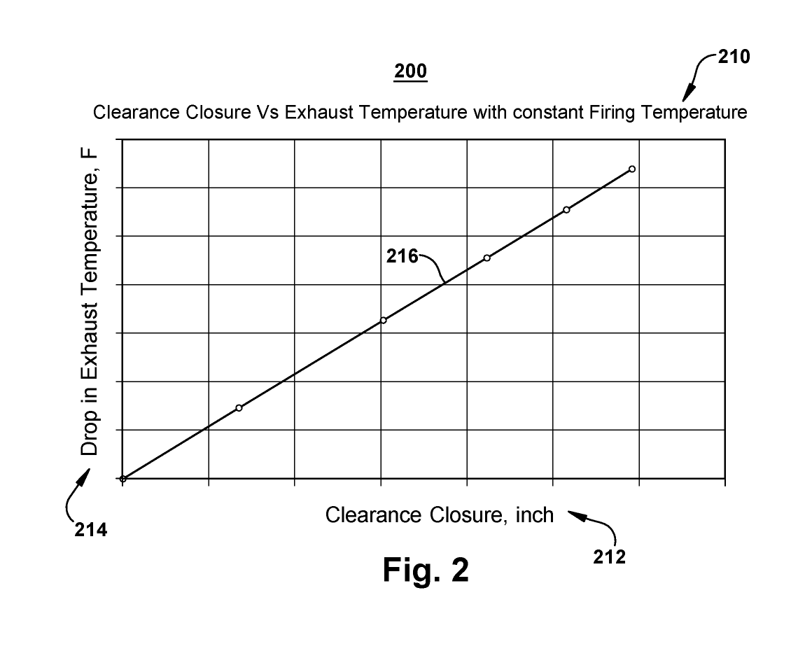

In some embodiments, control system 110 may include a virtual clearance measurement subsystem 111 that utilizes selected system measurements 112 from a plurality of system measurements that control system 110 utilizes for other system operations and management functions. For example, control system 110 may measure a plurality of system parameters 118 to manage operation of the gas turbine system based on air flow rate 160, fuel flow rate 162, turbine speed 164, and temperature, e.g., ambient temperature 166, firing temperature 168, exhaust temperature 170, etc. Control system 110 may monitor and adjust system parameters 118 and other parameters to control the air flow rate 166, fuel flow rate 162, and turbine speed 164 to achieve desired operating conditions for gas turbine 130. For example, system parameters 118 may include air flow rate 160, fuel flow rate 162, turbine speed 164, ambient temperature 166, firing temperature 168, and exhaust temperature 170. Virtual clearance measurement subsystem 111 may use selected system measurements 112 and a virtual clearance function 114 to generate a virtual clearance measurement value 116 without directly measuring the clearance distance in gas turbine 130. For example, system measurements 112 may include a combination of gas turbine exhaust temperature 170 and a combustor performance value, such as fuel flow rate 162 or firing temperature 168. Virtual clearance function 114 may include a transfer function for converting one of system measurements 112 into virtual clearance measurement value 116. In some embodiments, these transfer functions are represented graphically and are further explained with regard to FIGS. 2-4. Virtual clearance function 114 may include one or more other parameters from system measurements 112, but use them as a constant or other factor related to the transfer function. In addition, a calibration process may introduce one or more other factors for adjusting the transfer function by either translating an entire curve or modifying a certain operating range for an observed difference from a calculated clearance model. In some embodiments, virtual clearance measurement value 116 is a clearance distance measurement with a data type appropriate for input to clearance controller 120 and similar to the clearance measurement input signal clearance controller 120 would expect from a clearance probe or other measured clearance value.

Control system 110 may communicate with or includes a clearance controller 120 that may include a closed loop controller 122 for dynamically managing the clearance of a clearance control mechanism 150 associated with gas turbine 130. Closed loop controller 122 may include a control loop including a plurality of inputs to generate a clearance control signal 126 to clearance control mechanism 150. In some embodiments, closed loop controller 122 may use a desired clearance set point 124 as the target parameter for closed loop control and may receive a clearance measurement value that provides the real-time control input to which closed loop controller 122 responds and corrects. For example, clearance controller 120 may have an input parameter for clearance measurement. In some embodiments, clearance measurement values may be received from control system 110, such as virtual clearance measurement value 116. In some embodiments, a difference between desired clearance set point 124 and virtual clearance measurement value 116 may be injected into a control loop of closed loop controller 122 to modify clearance control signal 126 to clearance control mechanism 150 and adjust the clearance distance in gas turbine 130. In some embodiments, clearance control signal 126 is not a distance value for the clearance distance but a related control parameter, such as temperature for a thermal clearance control mechanism.

Gas turbine 130 may include any kind of conventional turbomachine including a compressor 132, combustor 134, and a turbine section 136. Turbine section 136 may include a plurality of stages, including a first stage along the fluid flow path through turbine section 136. For example, turbine section 136 may include an example stage 138 including airfoil blades 140, 142 with clearance distance 144, 146 to casing 148. The portion of casing 148 adjacent and closest to stage 138 of airfoil blades 140, 142 defines clearance distance 144, 146 between the stage 138 of airfoil blades 140, 142 and casing 148. Gas turbine 130 may further comprise clearance control mechanism 150. For example, clearance control mechanism 150 may include a case temperature management blower or a mechanical, hydraulic, or pneumatic actuator for adjusting clearance distance 144, 146 between airfoil blades 140, 142 and the adjacent casing 148. Clearance control mechanism 150 adjusts clearance distance 144, 146 in response to clearance control signal 126. In one embodiment, clearance control mechanism 150 may include an actuator and a feedback loop for adjustably controlling clearance distances 144, 146 between the maximum and minimum distances available based on the geometry and adjustment capabilities of the system. In some embodiments, clearance control mechanism 150 may be used to minimize clearance distances 144, 146 to reduce fluid leak and increase system efficiency during steady-state operation of gas turbine 130. In some embodiments, gas turbine 130 may be equipped with a plurality of sensors for measuring various operating system parameters, such as system parameters 118, and providing those measurements to control system 110. For example, one or more sensors in or proximate to compressor 132 may provide air flow rate 160 values and ambient temperature 166 values to control system 110 via compressor measurement signals 152. One or more sensors proximate to combustor 134 or a related fuel system may provide fuel flow rate 162 values and firing temperature 168 values to control system 110 via combustor measurement signals 154. One or more sensors in turbine section 136 may provide turbine speed 164 values and exhaust temperature 170 values to control system 110 via turbine measurement signals 156.

FIG. 2 shows an example virtual clearance function 200 represented as graph 210. Graph 210 relates airfoil clearance closure 212 on the x-axis to drop in exhaust temperature 214 on the y-axis. A curve 216 represents the transfer function for converting changes in exhaust temperature to changes in clearance distance. In the graph shown, airfoil clearance closure 212 is shown in inches and drop in exhaust temperature 214 is shown in degrees Fahrenheit. In some embodiments, curve 216 may further represent an additional system measurement parameter in that firing temperature is assumed to be held at a constant temperature.

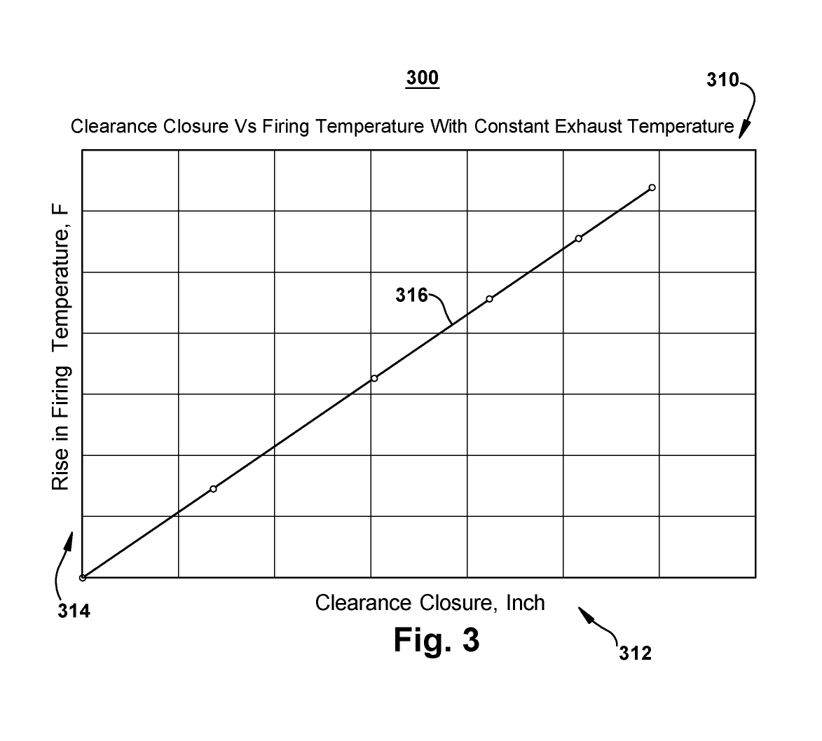

FIG. 3 shows another example virtual clearance function 300 represented as graph 310. Graph 310 relates airfoil clearance closure 312 on the x-axis to rise in firing temperature 314 on the y-axis. A curve 316 represents the transfer function for converting changes firing temperature to changes in clearance distance. In the graph shown, airfoil clearance closure 312 is shown in inches, and drop in firing temperature 314 is shown in degrees Fahrenheit. In some embodiments, curve 316 may further represent an additional system measurement parameter in that exhaust temperature is assumed to be held at a constant temperature.

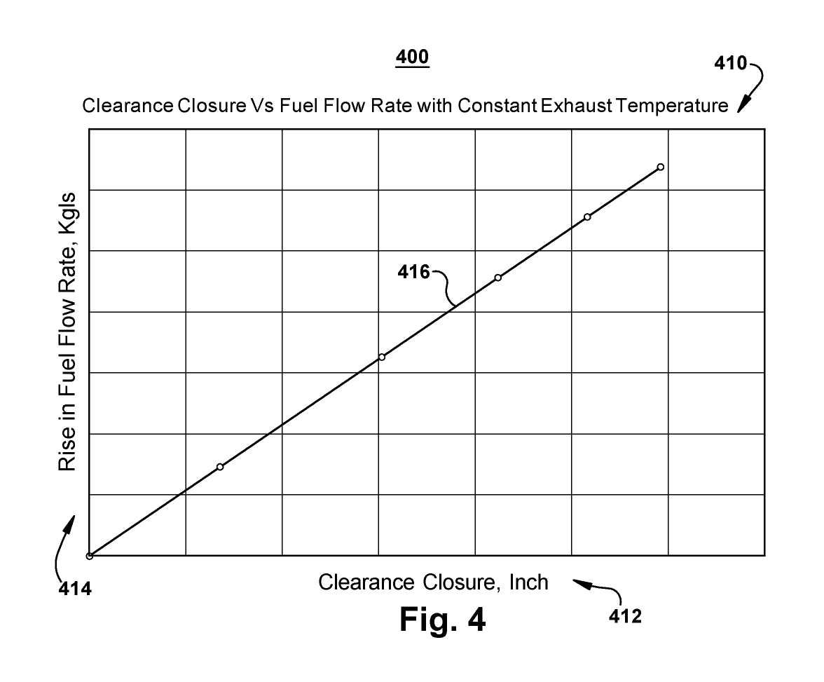

FIG. 4 shows another example virtual clearance function 400 represented as graph 410. Graph 410 relates airfoil clearance closure 412 on the x-axis to rise in fuel flow rate 414 on the y-axis. A curve 416 represents the transfer function for converting changes fuel flow rate to changes in clearance distance. In the graph shown, airfoil clearance closure 412 is shown in inches, and rise in fuel flow rate 414 is shown in degrees Fahrenheit. In some embodiments, curve 416 may further represent an additional system measurement parameter in that exhaust temperature is assumed to be held at a constant temperature.

Note that the value ranges and curves shown in FIGS. 2-4 may be simplified and abstracted examples and are not intended to provide accurate values or transfer functions, which may be based on the actual operating parameters of a particular gas turbine design. They are provided as examples only with the understanding that one of skill in the art would be able to develop their own virtual clearance functions based on the example correlations between system parameters and clearance values. The examples provided may not be exhaustive and additional correlations based on the transformation of a single measured system value to a virtual clearance measurement value may be possible. In addition, more complex and multivariable correlations may also be possible and subject to a similar method of virtualizing the clearance measurement based on system measurement data already available to the control system.

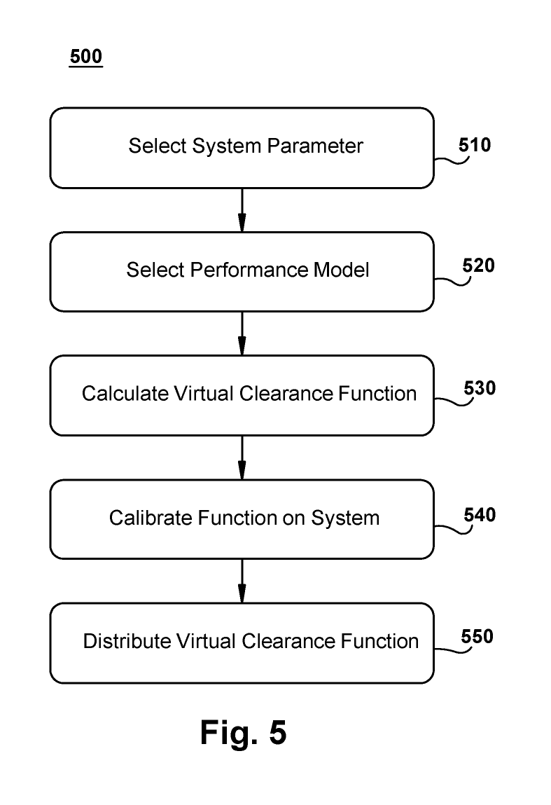

Referring to FIG. 5, an example method of generating and implementing a virtual clearance function (e.g., virtual clearance function 114) is shown. In process 510, one or more system measurement parameters (e.g., system parameters 118) may be selected for use in the virtual clearance function of a particular gas turbine design. For example, a combustor performance parameter may be selected that is known to be compatible with exhaust temperature in calculating a virtual clearance measurement value. In process 520, a performance model for the gas turbine design may be selected that includes the selected system measurement parameters and a clearance parameter. For example, the performance model may include the selected combustor performance parameter, an exhaust temperature parameter, and a clearance parameter correlating to the clearance distance in a range of operating conditions. The range of operating conditions may correlate to ranges of temperatures, flow rates, or other measurable values within the operating ranges defined for a particular gas turbine design and/or performance model. In process 530, a virtual clearance function may be calculated by plotting selected system measurement parameters against the clearance parameter to create a base transfer function. For example, a virtual clearance function may be calculated that includes a transfer function from one of the selected combustor performance parameter or the exhaust temperature parameter to the clearance parameter. In some embodiments, the base transfer function may be sufficiently accurate for field deployment. For example, the virtual clearance function may be added to a control system (e.g., control system 110) to generate a clearance control signal through a clearance controller (e.g., clearance controller 120) and to a clearance control mechanism (e.g., clearance control mechanism 150) based on measurement of the selected combustor performance parameter and the exhaust temperature parameter (e.g., system measurements 112) in a gas turbine in the field. The clearance control mechanism can then modify the clearance distance between the stage of airfoils and the casing in the airfoil using the clearance control mechanism in response to the clearance control signal. In process 540, the base transfer function of the virtual clearance function may be calibrated using a test system matching the gas turbine design. For example, the virtual clearance function may be calibrated on a gas turbine test unit having a clearance sensor generating at least one clearance measurement that can be compared against the corresponding virtual clearance measurement value and then used to modify the transfer function. In process 550, a calibrated virtual clearance function may then be distributed to corresponding gas turbines for use instead of a direct sensor based clearance measurement. For example, the virtual clearance function may be implemented in virtual clearance measurement subsystem that is added to control systems for new units before they go into the field or as a retrofit to field units that have lost the use of their clearance sensors for some reason.

The foregoing drawings show some of the operational processing associated according to several embodiments of this disclosure. It should be noted that in some alternative implementations, the acts described may occur out of the order described or may in fact be executed substantially concurrently or in the reverse order, depending upon the act involved.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

We claim:

1. A gas turbine system comprising:
a stage of airfoils;
a casing adjacent the stage of airfoils and defining a clearance distance between the stage of airfoils and the casing;
a clearance control mechanism that controllably adjusts the clearance distance based upon a clearance control signal;
a clearance controller providing the clearance control signal to the clearance control mechanism, wherein the clearance controller receives a clearance value as an input to a closed loop controller that generates the clearance control signal; and
a virtual clearance function that generates the clearance value from at least one system measurement of the gas turbine system.

2. The gas turbine system as claimed in claim 1, further comprising a gas turbine control system that measures a plurality of system parameters to manage operation of the gas turbine system based on air flow rate, fuel flow rate, turbine speed, and temperature, the gas turbine control system controlling the air flow rate, fuel flow rate, and turbine speed based on the plurality of system parameters, and wherein the at least one system measurement is selected from the plurality of system parameters.

3. The gas turbine system as claimed in claim 2, wherein the gas turbine control system receives the at least one system measurement, transforms the at least one system measurement with the virtual clearance function, and generates the clearance value, and the clearance controller receives the clearance value from the gas turbine control system.

4. The gas turbine system as claimed in claim 1, wherein the at least one system measurement includes a firing temperature and an exhaust temperature, and the virtual clearance function transforms an exhaust temperature value to the clearance value at a fixed firing temperature.

5. The gas turbine system as claimed in claim 1, wherein the at least one system measurement includes a firing temperature and an exhaust temperature, and the virtual clearance function transforms a firing temperature value to the clearance value at a fixed exhaust temperature value.

6. The gas turbine system as claimed in claim 1, wherein the at least one system measurement includes a fuel flow rate and an exhaust temperature, and the virtual clearance function transforms a fuel flow rate value to the clearance value at a fixed exhaust temperature value.

7. The gas turbine system as claimed in claim 1, wherein the virtual clearance function transforms combustor performance values and exhaust temperature values into the clearance value.

8. A method comprising:
measuring an exhaust temperature from a gas turbine, the gas turbine including a stage of airfoils and a casing adjacent the stage of airfoils and having a clearance distance between the stage of airfoils and the casing;
calculating a clearance value using a virtual clearance function to transform at least one combustor performance value and an exhaust temperature value into the clearance value;
generating a clearance control signal to a clearance control mechanism, the clearance control signal based on a closed loop controller and the clearance value; and
modifying the clearance distance between the stage of airfoils and the casing in response to the clearance control value using the clearance control mechanism.

9. The method as claimed in claim 8, wherein the measuring and calculating are performed by a gas turbine control system that measures a plurality of system parameters to manage operation of the gas turbine system based on air flow rate, fuel flow rate, turbine speed, and temperature, the gas turbine control system controlling the air flow rate, fuel flow rate, and turbine speed based on the plurality of system parameters.

10. The method as claimed in claim 9, wherein generating the clearance control signal is performed by a clearance controller that receives the clearance value from the gas turbine control system and outputs the clearance control signal to the clearance control mechanism for the gas turbine.

11. The method o as claimed in claim 8, wherein the at least one combustor performance value is a firing temperature and the virtual clearance function transforms the exhaust temperature value to the clearance value at a fixed firing temperature.

12. The method as claimed in claim 8, wherein the at least one combustor performance value is a firing temperature and the virtual clearance function transforms a firing temperature value to the clearance value at a fixed exhaust temperature value.

13. The method as claimed in claim 8, wherein the at least one combustor performance value is a fuel flow rate and the virtual clearance function transforms a fuel flow rate value to the clearance value at a fixed exhaust temperature value.

14. The method as claimed in claim 8, wherein the at least one combustor performance value and the exhaust temperature value are measured and used for controlling the air flow rate, fuel flow rate, and turbine speed in addition to calculating the clearance value.

15. A method comprising:
selecting a combustor performance parameter for a unit design for a gas turbine, the gas turbine including a stage of airfoils and a casing adjacent the stage of airfoils and having a clearance distance between the stage of airfoils and the casing;
selecting a performance model for the unit design for the gas turbine, the performance model including the selected combustor performance parameter, an exhaust temperature parameter, and a clearance parameter correlating to the clearance distance in a range of operating conditions;
calculating a virtual clearance function that includes a transfer function from one of the selected combustor performance parameter or the exhaust temperature parameter to the clearance parameter;
using the virtual clearance function to generate a clearance control signal to a clearance control mechanism based on measurement of the selected combustor performance parameter and the exhaust temperature parameter in the gas turbine; and
modifying the clearance distance between the stage of airfoils and the casing in response to the clearance control value using the clearance control mechanism.

16. The method as claimed in claim 15, further comprising calibrating the virtual clearance function on a gas turbine test unit having a clearance sensor generating at least one clearance measurement to modify the transfer function based on the at least one clearance measurement, and distributing the modified virtual clearance function to a plurality of field units of the gas turbine.

17. The method as claimed in claim 15, wherein using the virtual clearance function includes calculating a clearance value using the virtual clearance function to transform at least one combustor performance value and an exhaust temperature value into the clearance value and generating the clearance control signal based on a closed loop controller and the clearance value.

18. The method as claimed in claim 17, wherein the at least one combustor performance value is a firing temperature and the virtual clearance function transforms a firing temperature value to the clearance value at a fixed exhaust temperature value.

19. The method as claimed in claim 17, wherein the at least one combustor performance value is a fuel flow rate and the virtual clearance function transforms a fuel flow rate value to the clearance value at a fixed exhaust temperature value.

20. The method as claimed in claim 17, wherein the at least one combustor performance value and the exhaust temperature value are measured and used for controlling the air flow rate, fuel flow rate, and turbine speed in addition to calculating the clearance value.
